(19) United States
(12) Patent Application Publication
(10) Pub. No.: US 2020/0016019 A1
(43) Pub. Date: Jan. 16, 2020

(54) Massage Device

(71) Applicant: Ari Farha, Ann Arbor, MI (US)

(72) Inventor: Ari Farha, Ann Arbor, MI (US)

(21) Appl. No.: 16/505,175

(22) Filed: Jul. 8, 2019

Related U.S. Application Data
(60) Provisional application No. 62/698,207, filed on Jul. 15, 2018.

(51) Int. Cl. A61H 1/00; A61H 7/00; A61H 23/02

(52) U.S. Cl. CPC A61H 1/005; A61H 7/007; A61H 2205/12; A61H 2201/1642; A61H 2201/169; A61H 23/02

(57) ABSTRACT

Disclosed is a massage device. The massage device comprises a main body, gel-filled capsules, and at least one motor. The main body includes a left supporting groove and a right supporting groove, wherein a user inserts lower left leg in the left supporting groove and lower right leg in the right supporting groove to use the massage device. The gel-filled capsules lined along the outer surface of the left supporting groove and the right supporting groove. The at least one motor installed on a rear side of at least one of the left supporting groove and the right supporting groove. Further, the at least one motor is installed within the main body, wherein the at least one motor is configured to vibrate the gel-filled capsules.

### RELATED APPLICATION(S)

Under provisions of 35 U.S.C. § 119e, the Applicant(s) claim the benefit of U.S. provisional application No. 62/698,207, filed on Jul. 15, 2018, which is incorporated herein by reference.

### FIELD OF THE INVENTION

The invention relates generally to electric massage devices and accessories, and in particular to a vibrating massage device for lower legs and feet.

### BACKGROUND OF THE INVENTION

For millions of people throughout the world, the challenges of standing, walking, and climbing stairs for extended periods produce sore legs and feet on a regular basis. Electric massage devices have proven to be effective on other portions of the body. Several devices have been developed for the lower legs and feet, but each has been less than satisfactory in its own way. Some conventional devices do not apply the required pressure, while some other conventional devices do not employ an efficient massaging technique.

Accordingly, there is a need for an improved massage device that may overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Accordingly, the invention is directed to a massage device. The massage device comprises a main body, gel-filled capsules, and at least one motor. The main body includes a left supporting groove and a right supporting groove, wherein a user inserts lower left leg in the left supporting groove and lower right leg in the right supporting groove to use the massage device. The gel-filled capsules lined along the outer surface of the left supporting groove and the right supporting groove. The at least one motor installed on a rear side of at least one of the left supporting groove and the right supporting groove. Further, the at least one motor is installed within the main body, wherein the at least one motor is configured to vibrate the gel-filled capsules.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front view of a massage device, in accordance with an exemplary embodiment.

FIG. 2 is a right-side view of the massage device, in accordance with an exemplary embodiment.

FIG. 3 is a top view of the massage device, in accordance with an exemplary embodiment.

FIG. 4 is a rear view of the massage device, in accordance with an exemplary embodiment.

FIG. 5 is a front left-side perspective view of the massage device, in accordance with an exemplary embodiment.

FIG. 6 is a front right-side perspective view of the massage device, in accordance with an exemplary embodiment.

FIG. 7 is a top front perspective view of the massage device, in accordance with an exemplary embodiment.

FIG. 8 is a rear left-side perspective view of the massage device, in accordance with an exemplary embodiment.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of massage devices, embodiments of the present disclosure are not limited to use only in this context.

Overview:

According to some embodiments, the invention is directed to a vibrating massage device for lower legs and feet. The device provides three longitudinal walls, a transverse wall at the rear, and an endcap at the front. Within the device, gel-filled capsules are affixed firmly to the longitudinal walls in adjustable positions. Electric servo motors within the longitudinal walls cause the longitudinal walls to vibrate. The vibrations are thus transmitted to the capsules. The user may insert the lower legs and feet between the gel-filled capsules to experience a massaging effect from the vibrations.

The disclosed vibrating massage device for lower legs and feet may provide adjustable gel-filled capsules to distribute vibration firmly and evenly to the lower legs and feet regardless of the user's height and weight.

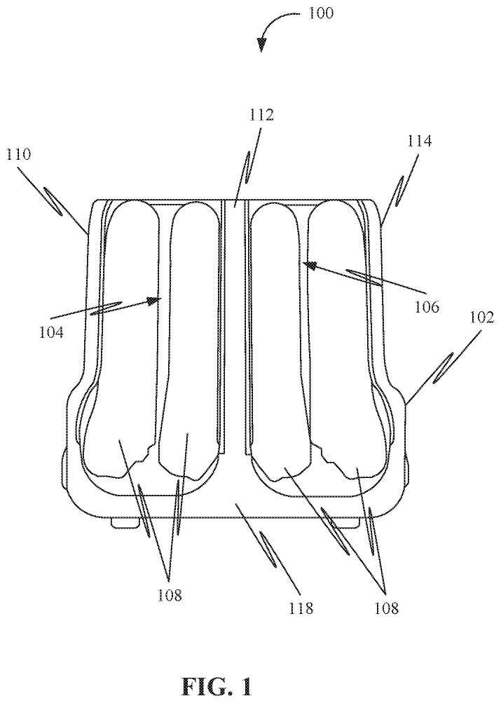

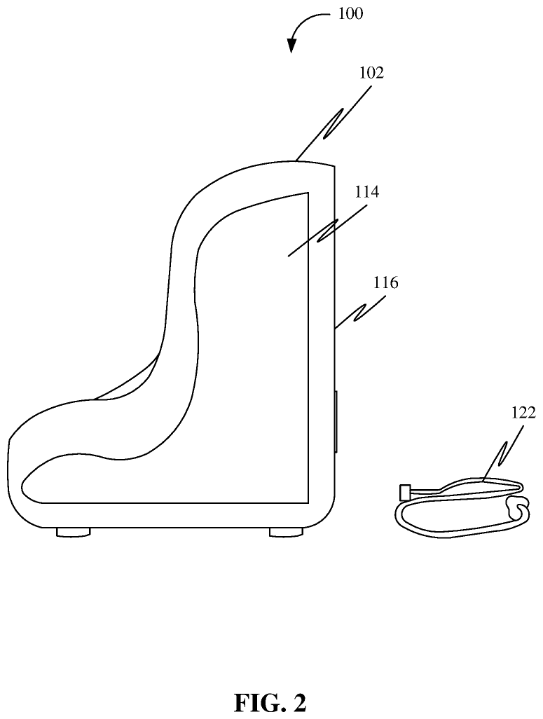

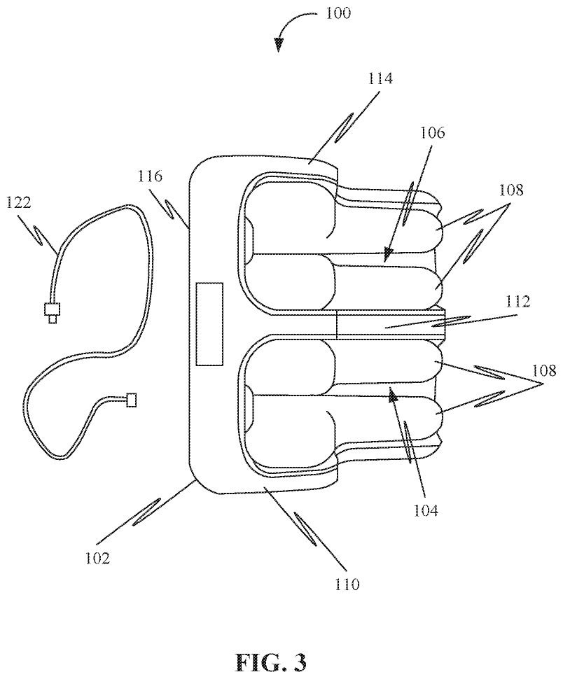

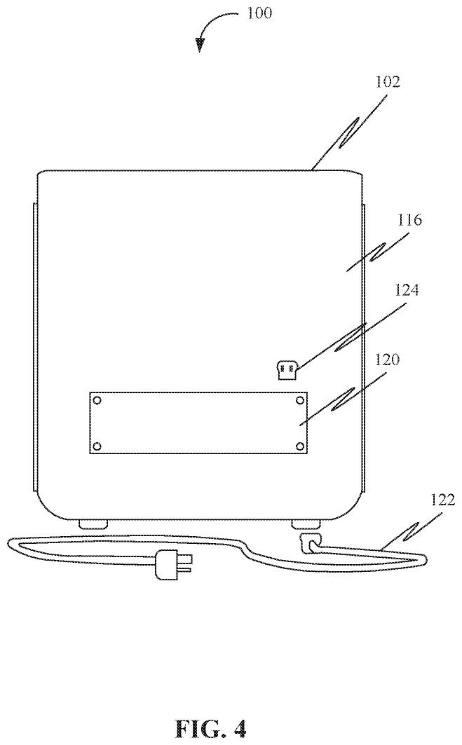

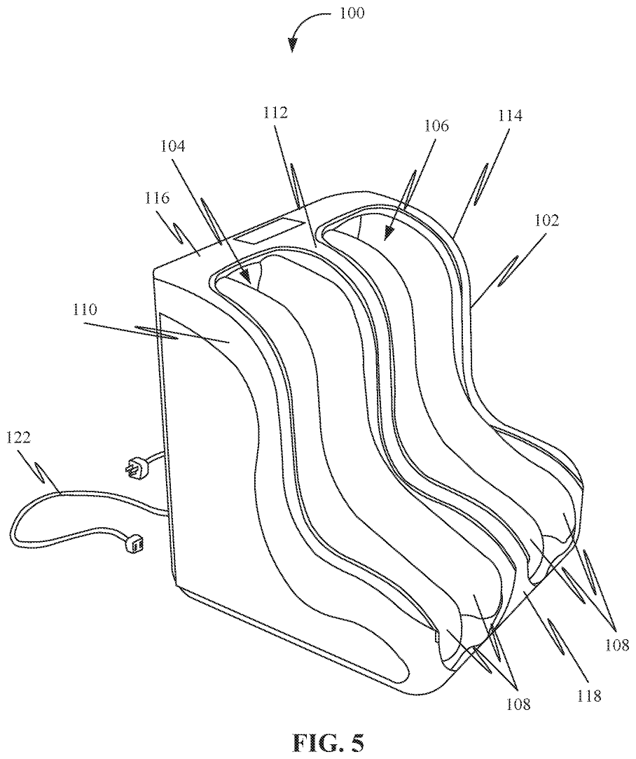

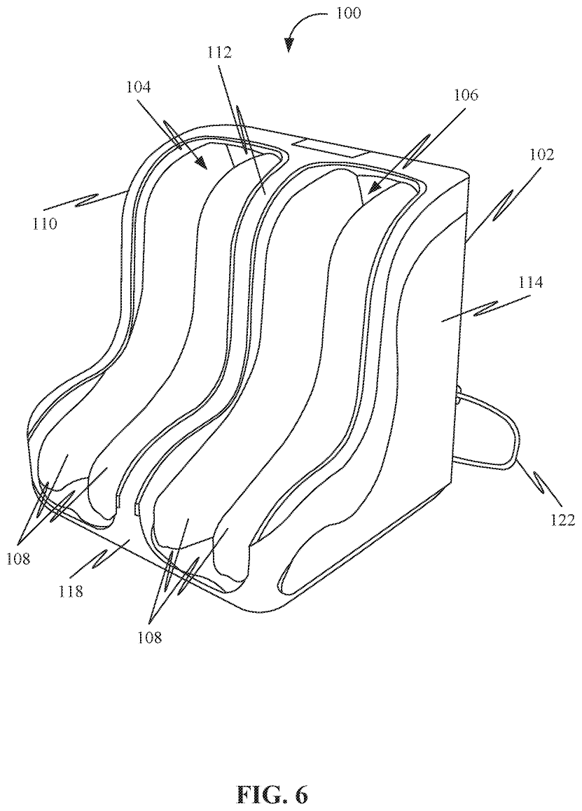

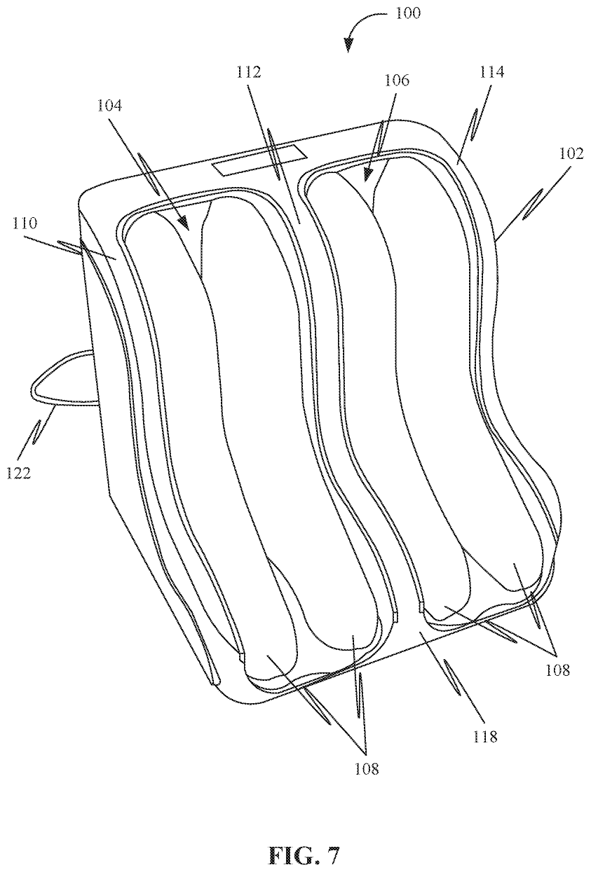

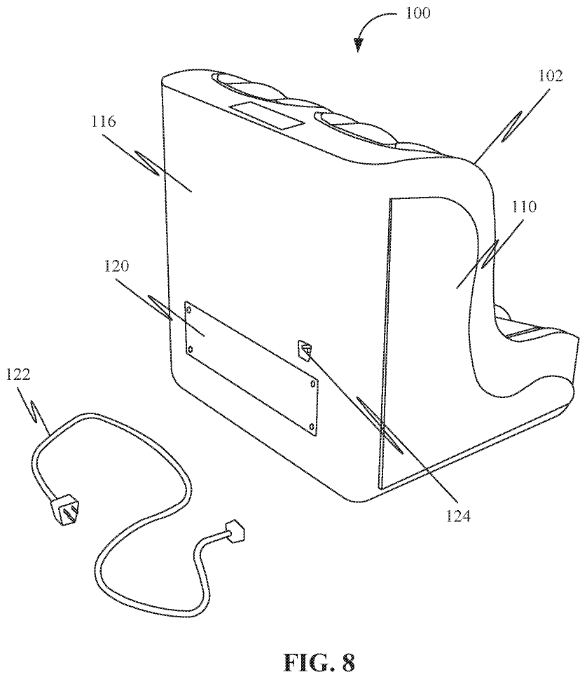

FIG. 1 is a front view of a massage device 100, in accordance with an exemplary embodiment. FIG. 2 is a right-side view of the massage device 100. FIG. 3 is a top view of the massage device 100. FIG. 4 is a rear view of the massage device 100. FIG. 5 is a front left-side perspective view of the massage device 100. FIG. 6 is a front right-side perspective view of the massage device 100. FIG. 7 is a top front perspective view of the massage device 100. FIG. 8 is a rear left-side perspective view of the massage device 100. The massage device 10 may be a vibrating massage device for lower legs and feet.

In some embodiments, the massage device 100 comprises a main body 102, gel-filled capsules 108 and at least one motor. The main body 102 includes a left supporting groove 104 and a right supporting groove 106, wherein a user inserts lower left leg (not shown) in the left supporting groove 104 and lower right leg (not shown) in the right supporting groove 106 to use the massage device 100. The lower left leg includes the left calf and the left foot. The lower right leg includes the right calf and the right foot.

Further, the gel-filled capsules 108 may be lined along the outer surface of the left supporting groove 104 and the right supporting groove 106. In some embodiments, the gel-filled capsules 108 may be manufactured from a flexible and durable material, such as plastic, rubber, or silicon. In some embodiments, the gel-filled capsules 108 may be affixed firmly to the longitudinal walls 110-114 in adjustable positions.

In some embodiments, the gel-filled capsules 108 may be removable from the main body 102 to allow for cleaning the gel-filled capsules 108.

Further, the at least one motor (not shown) installed on a rear side of at least one of the left supporting groove 104 and the right supporting groove 106. Further, the at least one motor is installed within the main body 102. Further, the at least one motor is configured to vibrate the gel-filled capsules 108. In some embodiments, the at least one motor includes at least one electric servomotor.

In some embodiments, the main body 102 may include three generally parallel longitudinal walls 110-114, a transverse wall 116 at the rear, and an endcap 118 at the front. Further, a front surface of the transverse wall 116 may be affixed with at least one edge of each of the three parallel longitudinal walls 110-114. Further, the endcap 118 may be affixed with at least a portion of each of the three longitudinal walls 110-114. In further embodiments, the three longitudinal walls 110-114 may include a left longitudinal wall 110, a central longitudinal wall 112, and a right longitudinal wall 114. Further, the left supporting groove 104 may be positioned between the left longitudinal wall 110 and the central longitudinal wall 112. Further, the right supporting groove 106 may be positioned between the central longitudinal wall 112 and the right longitudinal wall 114.

In further embodiments, the gel-filled capsules 108 may be affixed to at least one surface of at least one of the three longitudinal walls 110-114. Further, the at least one motor may be configured to vibrate the three longitudinal walls 110-114.

In some embodiments, the at least one motor within the longitudinal walls 110-114 may cause the longitudinal walls 110-114 to vibrate. Then, the vibrations are transmitted to the gel-filled capsules 108.

In some embodiments, the massage device 100 may include a battery (not shown) accessible via a battery door 120 disposed on a rear surface of the transverse wall 116. The battery door 120 is shown in FIGS. 4 and 7. The battery door 120 may be operable between an open position and a closed position. Further, the battery provides power to the at least one motor. In some embodiments, the battery may be a high capacity internal battery pack.

In some embodiments, the massage device 100 may include a detachable power cord 122 to provide power to at least one of the at least one motor and the battery. The power cord 122 may be plugged into an electric socket 124 (any standard wall outlet) disposed on a rear surface of the transverse wall 116. The power cord 122 may be manufactured from braided copper alloy wire sheathed in plastic.

In some embodiments, the gel-filled capsules 108 may be disposed within rubber kneading pads attached to the outer surface of at least one of the left supporting groove 104 and the right supporting groove 106.

In some embodiments, the at least one motor may be used to move one or more mechanical components to vibrate the three longitudinal walls 110-114 and the gel-filled capsules 108.

In some embodiments, the main body 102 may include a bottom panel (not shown) affixed to each of the three parallel longitudinal walls 110-114, the transverse wall 116, and the endcap 118 to form a closed housing. The housing may include the at least one motor and the battery.

In some embodiments, the massage device 100 may further include a control panel (not shown) for controlling operational settings of the massage device 100. The control panel includes at least one of at least one button and at least one display.

Further, at least one the three longitudinal walls 110-114, the transverse wall 116, the endcap 118, the bottom panel, and the battery door are manufactured from a rigid and durable material, such as plastic, rubber, or silicon.

To use the massage device 100, the user may insert the lower legs and feet between the gel-filled capsules 108, then activate the vibrating action of the at least one motor to experience a massaging effect from the vibrations.

The various components, component sizes, and materials mentioned above are preferable, but artisans will recognize that alternate components and materials could be selected without altering the scope of the invention.

Although the invention has been explained in relation to its preferred embodiment, it is to be understood that many other possible modifications and variations can be made without departing from the spirit and scope of the invention.

What is claimed is:

1. A massage device comprising:
a main body provided with a left supporting groove and a right supporting groove, wherein a user inserts lower left leg in the left supporting groove and lower right leg in the right supporting groove to use the massage device;
gel-filled capsules lined along the outer surface of the left supporting groove and the right supporting groove; and
at least one motor installed on a rear side of at least one of the left supporting groove and the right supporting groove, wherein the at least one motor is installed within the main body, wherein the at least one motor is configured to vibrate the gel-filled capsules.

2. The massage device of claim 1, wherein the main body includes three generally parallel longitudinal walls, a transverse wall at the rear, and an endcap at the front, wherein a front surface of the transverse wall is affixed with at least one edge of each of the three parallel longitudinal walls, wherein the endcap is affixed with at least a portion of each of the three longitudinal walls.

3. The massage device of claim 2, wherein the three longitudinal walls include a left longitudinal wall, a central longitudinal wall, and a right longitudinal wall, wherein the left supporting groove is positioned between the left longitudinal wall and the central longitudinal wall, wherein the right supporting groove is positioned between the central longitudinal wall, and the right longitudinal wall.

4. The massage device of claim 2, wherein the main body includes a bottom panel affixed to each of the three parallel longitudinal walls, the transverse wall, and the endcap to form a closed housing.

5. The massage device of claim 2, wherein the gel-filled capsules are affixed to at least one surface of at least one of the three longitudinal walls.

6. The massage device of claim 2, wherein the at least one motor is configured to vibrate the three longitudinal walls.

7. The massage device of claim 2 comprising a battery accessible via a battery door disposed on a rear surface of the transverse wall, wherein the battery door is operable between an open position and a closed position, wherein the battery provides power to the at least one motor.

8. The massage device of claim 7 comprising a detachable power cord to provide power to at least one of the at least one motor and the battery.

9. The massage device of claim 2 wherein at least one the three longitudinal walls, the transverse wall, the endcap, a bottom panel, and a battery door are manufactured from a rigid and durable material.

10. The massage device of claim 1 wherein the gel-filled capsules are manufactured from a flexible and durable material.

11. The massage device of claim 1, wherein the at least one motor includes at least one electric servomotor.

12. The massage device of claim 1, wherein the gel-filled capsules are disposed within rubber kneading pads attached to the outer surface of at least one of the left supporting groove and the right supporting groove.

13. The massage device of claim 1 comprising a control panel for controlling operational settings of the massage device, wherein the control panel includes at least one of at least one button and at least one display.
